(19) United States
(12) Patent Application Publication
(10) Pub. No.: US 2006/0151704 A1
(43) Pub. Date: Jul. 13, 2006

(54) Laser-based material processing methods, system and subsystem for use therein for precision energy control

(76) Inventor: James J. Cordingley, Littleton, MA (US)

Correspondence Address: BROOKS KUSHMAN P.C., 1000 TOWN CENTER, TWENTY-SECOND FLOOR, SOUTHFIELD, MI, 48075, US

(21) Appl. No.: 11/317,047

(22) Filed: Dec. 23, 2005

Related U.S. Application Data
(60) Provisional application No. 60/640,341, filed on Dec. 30, 2004.

(51) Int. Cl. G01F 23/00

(52) U.S. Cl. 250/358.1

(57) ABSTRACT

A laser-based material processing method, system and subsystem for use therein for precision energy control are provided, wherein a bulk attenuator is switched across an RF driver output to greatly lower the overall RF output and resulting laser energy per pulse. The value of the attenuator determines the range of energies achievable, pj or fractions of pj's. More than one attenuator and switch can be used to achieve multiple energy ranges. After the bulk attenuator is switched in, the laser energy is greatly reduced and the RF driver can then be run again near full RF power where the SNR is much better. The input voltage from a DAC is also much higher so it is also not at the low end of its range where it is also noisy due to poor SNR. The method and system provides increased dynamic range, greater extinction (lower possible energies), better accuracy and stability due to higher SNR of the DAC input voltage and higher SNR in the RF driver.

### CROSS-REFERENCE TO RELATED PATENTS AND APPLICATIONS

This application claims the benefit of U.S. Provisional Application Ser. No. 60/643,341, filed Dec. 30, 2004. This application hereby incorporates the following U.S. patents and patent applications in their entirety herein: U.S. Pat. Nos. 6,791,059; 6,744,288; 6,727,458; 6,573,473; 6,381,259; 2002/0167581; 2004/0134896 and U.S. Pat. No. 6,559,412. These patents and publications are assigned to the Assignee of the present invention.

### BACKGROUND OF THE INVENTION

1. Field of the Invention

The present invention generally relates to precision, high-speed, laser-based material processing, for instance micro-machining of target material. One such application is laser-based repair of a redundant semiconductor memory.

2. Background Art

As semiconductor and DRAM device design rules advance to smaller geometries, smaller laser spots are required to remove smaller, more tightly spaced programmable links. As the geometry of the links becomes smaller, the energy per laser pulse required to process each link becomes smaller because less link material is removed. When processing smaller link geometries, a smaller laser spot size is also required to avoid damaging adjacent links or other structures. With a smaller laser spot size the energy density within the spot is higher thus requiring lower energy per pulse to remove link material.

More accurate control of the laser energy is beneficial to maintain precise and constant energy per pulse, or per group of pulses. Consistent material removal and more reliable link processing can be achieved with improved control. Such accurate control is generally beneficial for laser processing and precision micro-machining.

In addition to processing the links, operation of a laser system often includes aligning the laser beam to a device, target structure, or other material to be processed.

U.S. Pat. Nos. 5,196,867 and 6,947,454 and published U.S. applications 2005/0270631, 2005/0270630 and 2005/0270629 are related to the present application.

A need exists for a laser-based material processing system having very wide dynamic range in energy control to provide improved precision for both processing and alignment operations. In addition to wide dynamic range, the system needs very good resolution, stability, extinction, and accuracy in energy setting.

### SUMMARY OF THE INVENTION

An object of the present invention is to provide an improved laser processing method and system for precisely controlling laser output energy.

Yet another object of the invention is to provide a laser material processing method and system for precisely controlling laser output energy over a dynamic range large enough for both detection and laser processing operations.

One aspect of the invention features an energy control method for precisely controlling laser output energy over a wide dynamic range.

Another aspect of the invention features a laser material processing system for carrying out the method.

Embodiments of the present invention provide for very high resolution energy control and extinction over a wide dynamic range. It is expected that accuracy and stability of each energy setting will be greatly improved over previous methods and systems.

In carrying out the above object and other objects of the present invention, a laser-based material processing method is provided. The method includes irradiating a material with a first laser output having a first energy density. The first energy density is high enough to produce detectable laser radiation as a result of an interaction of the first laser output and the material, and low enough to avoid substantial modification of the material. The method further includes detecting at least a portion of the detectable laser radiation to produce data representative of a property of the material, analyzing the data and irradiating target material with a laser material processing output based on the analyzed data. The material processing output has a processing energy density that is substantially greater than the first energy density and high enough to modify a physical property of the target material and thereby process the target material.

The method may further include generating a first control signal to precisely control the first laser output.

The method may further include generating a second control signal to precisely control the material processing output.

The method may further include setting at least one of the control signals to within a high, signal-to-noise ratio operating range so that both the first laser output and the material processing output are precisely controlled over a wide dynamic range.

The at least one set control signal may be an analog or digital signal and the step of setting may include at least one of modulating, amplifying, attenuating, compressing, expanding, scaling, delaying, coding and shifting the at least one set control signal.

The method may further include selectively attenuating the at least one set control signal to produce at least one of a suitable first laser output and a suitable laser material processing output.

The at least one set control signal may be an RF signal, and the step of selectively attenuating may be carried out with a switched attenuator network.

The material may be the target material.

The processing energy density may be about 1000 times the first energy density.

The property of the material may be an optical property or a thermal property.

The property of the material may be a spatial property.

The data may represent a location of the target material.

Further in carrying out the above object and other objects of the present invention, a laser-based, material processing system is provided. The system includes a pulsed laser system for producing a first pulsed laser beam which interacts with material of an article to produce laser radiation and a second pulsed laser beam which processes target material in a laser processing operation. The system further includes at least one positioner for supporting the article. The system further includes a measurement subsystem for performing a measurement operation in response to at least a portion of the laser radiation and generating a corresponding measurement signal. The system further includes a system controller for controlling the at least one positioner and the pulsed laser system in response to the measurement signal. The system further includes beam delivery and focusing components coupled to the system controller for delivering and focusing the laser beams. The system further includes a modulator for modulating the laser beams and an energy controller coupled to the modulator for precisely controlling laser output energy of the laser beams over a dynamic range large enough for both the measurement and laser processing operations.

The energy controller may include a switched attenuator network.

The modulator may be an acousto-optic device.

The modulator may be an electro-optic device.

Still further in carrying out the above object and other objects of the present invention, a method for precisely controlling laser energy of a laser output at a position beyond a source of the laser output is provided. The method includes adjusting the laser energy to obtain scanning energy within an energy range low enough to non-destructively scan an article in a measurement operation. The method further includes adjusting the laser energy to obtain processing energy within an energy range high enough to process target material of the article.

Still further in carrying out the above object and other objects of the present invention, a subsystem for precisely controlling laser energy of a laser output at an optical modulator positioned beyond a source of the laser output is provided. The subsystem includes an energy controller for generating output control signals for the modulator wherein laser output energy from the modulator is controlled over a dynamic range large enough for both measurement and laser processing operations.

The energy controller may include a switched attenuator network.

The optical modulator may include an acousto-optic device.

The optical modulator may include an electro-optic device.

These and other features, aspects, and advantages of the invention will become better understood with regard to the following description, appended claims, and accompanying drawings.

### BRIEF DESCRIPTION OF THE DRAWINGS

FIG. 1 is a schematic block diagram that illustrates one embodiment of a laser material processing system that includes precision energy control.

### DETAILED DESCRIPTION OF THE PREFERRED EMBODIMENT(S)

Reference to “energy control” in the present disclosure is also is generally applicable to “power control,” “intensity control,” “peak power control,” “average power control” or similar related functions.

Laser-Based Memory Repair Methods/Systems

The following representative patents and published applications generally related to methods and systems for laser-based micro-machining, and more specifically related to memory repair:

U.S. Pat. No. 6,791,059, entitled “Laser Processing” (hereafter the '059 patent);

U.S. Pat. No. 6,744,288, entitled “High-Speed Precision Positioning Apparatus” (hereafter the '288 patent);

U.S. Pat. No. 6,727,458, entitled “Energy-Efficient, Laser-Based Method And System For Processing Target Material” (hereafter the '458 patent);

U.S. Pat. No. 6,573,473 entitled “Method And System For Precisely Positioning A Waist Of A Material-Processing Laser Beam To Process Microstructures Within A Laser-Processing Site” (hereafter the '473 patent);

U.S. Pat. No. 6,381,259 entitled “Controlling Laser Polarization” (hereafter the '259 patent);

Published U.S. Patent Application 2002/0167581, entitled “Methods And Systems For Thermal-Based Laser Processing A Multi-Material Device” (hereafter the '581 application);

Published U.S. Patent Application 2004/0134896, entitled “Laser-Based Method And System For Memory Link Processing With Picosecond Lasers” (hereafter the '896 application); and

U.S. Pat. No. 6,559,412 entitled “Laser Processing” (hereafter the '419 patent).

At least the following cited portions of the above documents are particularly pertinent to understand the various features, aspects, and advantages of the present invention:

FIG. 5 of the '059 patent and the corresponding text relate to a laser processing system for link blowing wherein an modulator (attenuator) is provided for pulse selection and energy control.

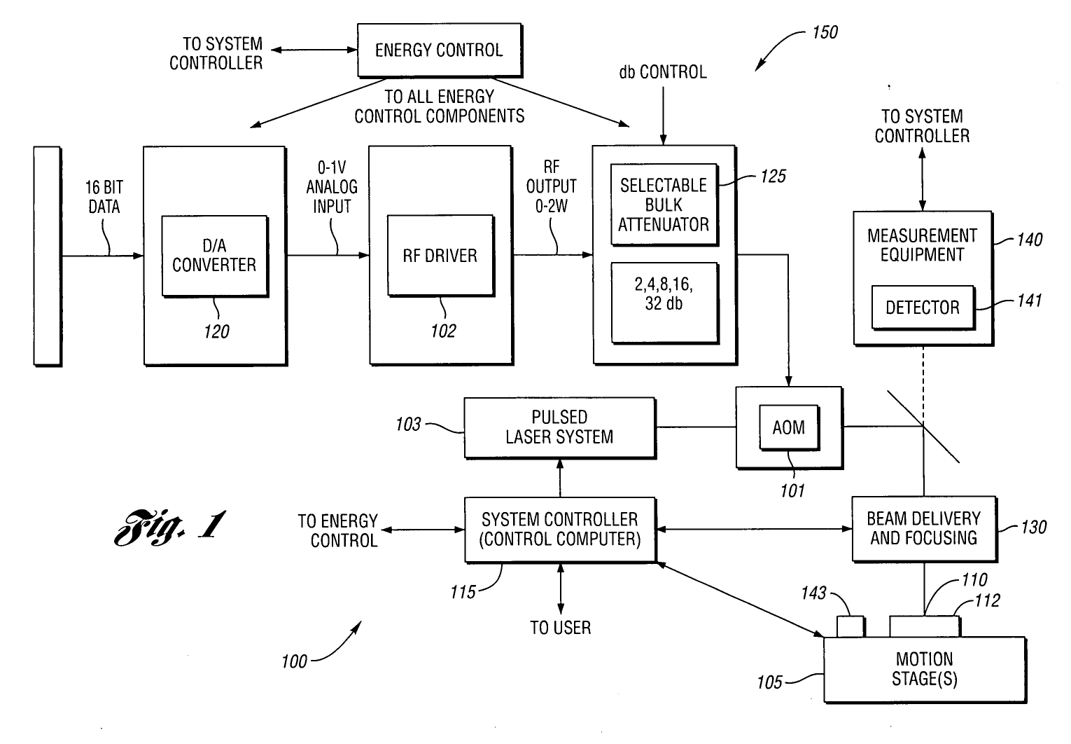

FIG. 1 of the '471 patent and the corresponding text relate to a laser processing system for link blowing wherein a modulator (attenuator) is provided for pulse selection and energy control. In at least one embodiment a laser output is generated having a wavelength less than 0.55 microns.

Numerous figures and the corresponding text in the '581 and '896 applications, and in the '458 patent, include at least one modulator for picking pulses and controlling laser energy.

FIGS. 10, 11, 12, 13, 14, and 14b and the corresponding text of the '581 application relate to an exemplary alignment and measurement method and system. A related application entitled “Methods and Systems for Precisely Relatively Positioning a Waist of a Pulsed Laser Beam and Method and System for Controlling Energy Delivered to a Target Structure,” is published as U.S. patent application 2002/0166845.

The '288 patent shows a wafer positioning apparatus, an example of a “wafer stage,” that may be used in carrying out at least one embodiment of the present invention.

FIGS. 4-6 and the corresponding text and, additionally, col 7, line 60-col 9, line 8 of the '473 patent generally relate to alignment and power control methods used in a material processing application, specifically link blowing.

Overview

One aspect of the invention features a laser material processing method. The method includes: irradiating a material with a first laser output having a first energy density, the first energy density being high enough to produce detectable laser radiation as a result of an interaction of the first laser output and the material, and low enough to avoid substantial modification of the material; detecting at least a portion of the detectable radiation to produce data representative of a property of the material; analyzing the data; irradiating target material with a laser material processing output having processing energy density that is substantially greater than the first energy density and high enough to modify a physical property of the target material and thereby process the material.

The method may include generating a first control signal to precisely control the first laser output.

The method may also include generating a laser material processing or second control signal to precisely control the laser material processing output.

The method may also include setting at least one of the first and second control signals to within a high signal to noise ratio operating range so that both the first laser output and the material processing output are precisely controlled over a wide dynamic range.

The at least one control signal may be an analog or digital signal. Setting the at least one control signal may include at least one step of modulating, amplifying, attenuating, compressing, expanding, scaling, delaying, coding, and shifting the signal.

The method may also include selectively attenuating at least one of the set signals to produce at least one of a suitable first laser output or suitable material processing output.

The set signal may be an RF signal, and the step of selectively attenuating may be carried out with a switched attenuator network.

In at least one embodiment the material may be the target material.

The energy density of the laser material processing output may be about 1000 times the first energy density.

The property of the material may be an optical property or thermal property.

The property of the material may be a spatial property.

The data may also represent a location of the material.

Another aspect of the invention features a system for carrying out the above laser processing method. FIG. 1 illustrates a system 100 of the present invention. The exemplary system includes a pulsed laser system 103, at least one positioner (i.e., motion stage(s)) 105, a measurement subsystem or equipment 140, a system controller (control computer) 115, beam delivery and focusing components 130, a modulator (AOM) 101, and an energy controller 150 for precisely controlling laser output energy 110 over a dynamic range large enough for both measurement and laser processing operations.

The energy controller 150 may include a switched attenuator network (selectable bulk attenuator) 125.

The modulator may be an acousto-optic device 101.

The modulator may be an electro-optic device with a controller for controlling a voltage.

Detection for Alignment, Measurement, or Imaging

With reference to FIG. 1, in many laser processing systems such as the system 100 various features are scanned and measured, or otherwise analyzed, using detection (i.e., measurement) equipment 140. The features are generally within a region of interest. Alignment may be carried out by scanning laser energy over features at a processing wavelength, illuminating an area with visible light and viewing features with an array camera, or a combination. When scanning with the processing laser 103 the laser energy 110 is first set to a non-destructive level under control of the modulator 101, and then alignment targets (not shown) on the device 112 are scanned or otherwise detected. Reflected energy from the alignment targets is analyzed and the location of the targets determined. By way of example, the typical energy required can be 1000 times lower than the link processing energy. Increasingly lower energies are required for scanning as the spot size is made smaller. The lower and lower scanning energies require very good extinction in an energy control circuit. Preferably, the system 101 is able to lower the energy to very close to zero to be able to maintain control of the energy setting.

Wide Dynamic Range Energy/Power Control

High accuracy and high bandwidth energy control on laser processing equipment is generally performed using the acousto optic modulator (AOM) 101 and an accompanying RF driver 102 to control the AOM 101.

The laser 103 is generally operated at a constant, high q-rate (pulsing rate) while the wafer or motion stage(s) 105 is moved at constant velocity. During most of the time the laser energy is set to an “OFF” state by the energy control system. The laser energy is adjusted if a pulse (or group of pulses) is needed to (1) process a link or other target material, align to a target, or to focus. The energy is adjusted by varying the RF power to the AOM 101.

A typical AOM 101 and RF driver 102 combination can perform fairly well as shown in the following table:

High Resolution Energy Control

| High Energy Range (blasting) | | | | | | | |
|---|---|---|---|---|---|---|---|
| | | | 4 | | | | |
| | | | 16 bit | | | | |
| 1 | | | DAC | Low Energy Range (scanning) | | | |
| High range | 2 | | resolution | 5 | 6 | 7 | |
| M4XX | RF driver | 3 | (nj) | attenuat | Low range | Low range | 8 |
| max | extinction | M435 min | (65535 | or value | M4XX max | min energy | resolution |
| energy (uj) | (db) | energy (nj) | bits) | (−db) | energy (nj) | (pj) | (pj) |
| 1.0 | −40 | 0.10 | 0.015259 | −1 | 794.3282347 | 79.43282347 | 12.12067193 |
| 1.0 | −40 | 0.10 | 0.015259 | −2 | 630.9573445 | 63.09573445 | 9.6279194 |
| 1.0 | −40 | 0.10 | 0.015259 | −4 | 398.1071706 | 39.81071706 | 6.07472603 |
| 1.0 | −40 | 0.10 | 0.015259 | −8 | 158.4893192 | 15.84893192 | 2.41839199 |
| 1.0 | −40 | 0.10 | 0.015259 | −16 | 25.11886432 | 2.51188643 | 0.38328930 |
| 1.0 | −40 | 0.10 | 0.015259 | −32 | 0.630957344 | 0.06309573 | 0.00962779 |

The typical ideal case for memory repair link blasting is demonstrated in columns 1-4 of the table. For a 1.0 μj (microjoule) laser energy input, which may be in response to a command from the system controller 115 or other specification, and a 16 bit DAC 120 the minimum achievable energy (extinction) is 0.10 nj (nanojoule). The resolution achieved is 0.015 nj. A problem is that the DAC 120 and the RF driver 102 are both operated at the very low end of their ranges where the signal is small and noisy. The resolution and the extinction of this ideal case are generally not achieved due to poor signal to noise ratio (SNR) in both the RF driver 102 and the input drive signal to the RF driver 102.

In an improved implementation, a selectable bulk attenuator 125 is switched across the RF driver output to greatly lower the overall RF output and resulting laser energy per pulse (modeled as columns 5-8 in the table). The value of the attenuator 125 determines the range of energies achievable, pj (picojoule) or fractions of a pj in the cases shown.

In at least one embodiment more than one attenuator and switch can be used to achieve multiple energy ranges.

One important point to note is that after the bulk attenuator 125 is switched in, the laser energy is greatly reduced and the RF driver 102 can then be run again near full RF power where the SNR is much better. The input voltage from the DAC 120 is also much higher so it is also not at the low end of its range where it is also noisy due to poor SNR. This embodiment illustrates various advantages of the present invention: increased dynamic range, greater extinction (lower possible energies), better accuracy and stability due to higher SNR of the DAC input voltage and higher SNR in the RF driver 102.

The exemplary operation is particularly suited for memory repair, but may be adapted for use in other precision laser based micro-machining operations: for instance marking, trimming, micro-drilling, micro-structuring, patterning, flat panel display or thin film circuit repair, and similar high-speed applications that require precision energy control of laser pulses that impinge target material.

The embodiment of FIG. 1 shows the acousto-optic modulator 101 and RF controller. Other embodiments may include an electro-optic (E-O) modulator, for instance a pockels cell, planar waveguide modulator, or other optical switch that operates over a suitable control range. Several such devices generally control polarization as a function of an input voltage. A “stepped” or switched transformation similar to that shown in FIG. 1, or other suitable scaling of the voltage, may be used to improve performance in laser processing system utilizing E-O modulators.

Embodiments of the present invention may also be used in system incorporating mode-locked or gain switched laser sources. By way of example, a pulse width may be in a range of about 1 picosecond (or shorter) to several hundred nanoseconds (or longer). Processing of target material may be carried out using a single pulse, or a plurality of pulses.

Further, at least one embodiment of the present invention may be carried out at infrared, visible and UV wavelengths, and may be particularly advantageous at short wavelengths.

Precision Calibration

Preferably, a system of the present invention is precisely calibrated over the entire wide dynamic range. Calibration is used to provide a transfer characteristic between a digital value at DAC 120 input and the laser output 110. One or more detectors 141 may be included with the measurement equipment 140, which is generally operatively coupled to the system controller 115. In at least one embodiment, a “power meter” 143 may be placed on a wafer stage 105, or proximate to the wafer stage 105, for a direct measurement of laser power, energy, or other pulse characteristic.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A laser-based material processing method comprising:
irradiating a material with a first laser output having a first energy density, the first energy density being high enough to produce detectable laser radiation as a result of an interaction of the first laser output and the material, and low enough to avoid substantial modification of the material;
detecting at least a portion of the detectable laser radiation to produce data representative of a property of the material;
analyzing the data; and
irradiating target material with a laser, material processing output based on the analyzed data, the material processing output having a processing energy density that is substantially greater than the first energy density and high enough to modify a physical property of the target material and thereby process the target material.

2. The method as claimed in claim 1, further comprising generating a first control signal to precisely control the first laser output.

3. The method as claimed in claim 2 further comprising generating a second control signal to precisely control the material processing output.

4. The method as claimed in claim 3, further comprising setting at least one of the control signals to within a high, signal-to-noise ratio operating range so that both the first laser output and the material processing output are precisely controlled over a wide dynamic range.

5. The method as claimed in claim 4, wherein the at least one set control signal is an analog or digital signal and wherein the step of setting includes at least one of modulating, amplifying, attenuating, compressing, expanding, scaling, delaying, coding and shifting the at least one set control signal.

6. The method as claimed in claim 4 further comprising selectively attenuating the at least one set control signal to produce at least one of a suitable first laser output and a suitable laser material processing output.

7. The method as claimed in claim 6, wherein the at least one set control signal is an RF signal, and wherein the step of selectively attenuating is carried out with a switched attenuator network.

8. The method as claimed in claim 1 wherein the material is the target material.

9. The method as claimed in claim 1, wherein the processing energy density is about 1000 times the first energy density.

10. The method as claimed in claim 1, wherein the property of the material is an optical property or a thermal property.

11. The method as claimed in claim 1, wherein the property of the material is a spatial property.

12. The method as claimed in claim 1, wherein the data represents a location of the target material.

13. A laser-based, material processing system comprising:
a pulsed laser system for producing a first pulsed laser beam which interacts with material of an article to produce laser radiation and a second pulsed laser beam which processes target material in a laser processing operation;
at least one positioner for supporting the article;
a measurement subsystem for performing a measurement operation in response to at least a portion of the laser radiation and generating a corresponding measurement signal;
a system controller for controlling the at least one positioner and the pulsed laser system in response to the measurement signal;
beam delivery and focusing components coupled to the system controller for delivering and focusing the laser beams;
a modulator for modulating the laser beams; and
an energy controller coupled to the modulator for precisely controlling laser output energy of the laser beams over a dynamic range large enough for both the measurement and laser processing operations.

14. The system as claimed in claim 13, wherein the energy controller includes a switched attenuator network.

15. The system as claimed in claim 13, wherein the modulator includes an acousto-optic device.

16. The system as claimed in claim 13, wherein the modulator includes an electro-optic device.

17. A method for precisely controlling laser energy of a laser output at a position beyond a source of the laser output, the method comprising:
adjusting the laser energy to obtain scanning energy within an energy range low enough to non-destructively scan an article in a measurement operation; and
adjusting the laser energy to obtain processing energy within an energy range high enough to process target material of the article.

18. A subsystem for precisely controlling laser energy of a laser output at an optical modulator positioned beyond a source of the laser output, the subsystem comprising:
an energy controller for generating output control signals for the modulator wherein laser output energy from the modulator is controlled over a dynamic range large enough for both measurement and laser processing operations.

19. The subsystem as claimed in claim 18, wherein the energy controller includes a switched attenuator network.

20. The subsystem as claimed in claim 18, wherein the optical modulator includes an acousto-optic device.

21. The subsystem as claimed in claim 18, wherein the optical modulator includes an electro-optic device.
